(19) United States
(12) Patent Application Publication
(10) Pub. No.: US 2011/0275551 A1
(43) Pub. Date: Nov. 10, 2011

(54) INCORPORATION OF DYE INTO GRANULAR LAUNDRY DETERGENT

(76) Inventors: Stephen Norman Batchelor, Wirral (GB); Jayne Michelle Bird, Wirrel (GB); Susan Barbara Joyce, Wirral (GB)

(21) Appl. No.: 13/145,165

(22) PCT Filed: Jan. 8, 2010
(86) PCT No.: PCT/EP2010/050138

§ 371 Date: Jul. 19, 2011

(30) Foreign Application Priority Data
Jan. 26, 2009 (EP) 09151297.0

(51) Int. Cl. C11D 3/60

(52) U.S. Cl. 510/324; 510/276

(57) ABSTRACT

The present invention concerns a shading dye containing granule.

### TECHNICAL FIELD

The present invention concerns laundry shading dye compositions.

### BACKGROUND

WO2006/032397 (Unilever) discloses the use of blue and violet hydrophobic anthraquinone dyes for shading white polyester garments during domestic washing. Blue and violet shading of a garment enhances its whiteness.

WO2006/045375 (Unilever) discloses the use of blue and violet hydrophobic benzodifuranes, methine, triphenylmethanes, napthalimides, pyrazole, napthoquinone and mono-azo or di-azo dyes for shading white polyester garments during domestic washing.

WO2006/053598 (Unilever) discloses a granule for delivery of hydrophobic dyes from wash solution, the granule comprising: (i) between 5 to 40 wt % of a non-ionic surfactant having dissolved therein between 0.0001 to 5% wt % of a dye, wherein the dye has a solubility in the non-ionic surfactant of at least 0.01 wt %; (ii) between 20 to 90 wt % of a solid carrier.

For delivery of hydrophobic dyes from wash solution WO2007/006357 (Unilever) disclosed a granule comprising between 5 to 40 wt % of non-volatile water miscible solvent having dissolved therein between 0.0001 to 4 wt % of a dye, wherein the dye has a solubility in the solvent of at least 0.01 wt %, the non-volatile water miscible solvent other than a non-ionic surfactant; (ii) between 20 to 90 wt % of a solid carrier; (iii) between 0 to 50 wt % of a binder; and, (iv) between 0 to 1 wt % of a photo-bleach.

There is a need for simpler methods to incorporate blue and violet dyes into granular laundry detergents that are storage stable and upon use provide shading benefits.

### SUMMARY OF INVENTION

We have found that it is possible to use a simple dye containing granule to formulate a granular laundry detergent composition that has acceptable properties for a wide range of shading dyes. The granular laundry detergent composition has reduced dye migration in the formulation and acceptable dye deposition to a fabric when used under domestic conditions.

In one aspect the present invention provides a granular laundry detergent composition comprising:

(a) from 0.00005 to 0.2 wt % of a dye granule, wherein the dye granule comprises:
(i) 20 to 60 wt % of a shading dye;
(ii) 40 to 80 wt % of a dispersant selected from: ligninsulphonates; alkali metal salts of the condensation products of naphthalenesulphonic acids and formaldehyde;
polyvinylsulphonates; and, ethoxylated novolacs;
(iii) 0 to 10 of wt % auxiliary agents selected from: anionic surfactants; non-ionic surfactants; acidic polymers; and dust proofing oil;
(b) from 5 to 50 wt % of a surfactant;
(c) from 5 to 50 wt % builder selected from: calcium sequestrant materials; precipitating materials; and,
calcium ion-exchange materials; and,
(d) 0.05 to 50 wt % a water soluble carrier salt; and,
(e) 0 to 20 wt % other ingredients.

Preferably the alkali metal salt of the condensation products of naphthalenesulphonic acids and formaldehyde is sodium.

The shading dye preferably has a calculated log P (octanol-water partition coefficient) of between 0.5 and 3 more preferably between 1.0 and 2.5. Log P values are atom based and calculated using Molecular Modeling Pro (version 5.2.2, © Norgwyn Montgomery Softwear limited).

### DETAILED DESCRIPTION OF THE INVENTION

### Dye Granules

The granules are preferably formed by drying a liquid slurry or solution of the materials, for example by vacuum drying, freeze drying, drying in drum dryers, Spin Flash® (Anhydro), but most preferably by spray drying. Most preferably the liquid is water and the shading dye and dispersant are ground before or during the making of the slurry. This grinding is preferably accomplished in mills, such as for example ball, swing, bead or sand mills, or in kneaders.

The production of such granules is discussed in WO2006/131530. Such granules are suitably made immediately after synthesis of the dye.

Preferably, the dye granules have an average particle size, APS, from 0.1 to 300 microns, preferably 10 to 100 microns. Preferably this is as measured by a laser diffraction particle size analyser, preferably a Malvern HP with 100 mm lens.

The dye granules are preferably post-dosed into the powder in a 0.1 to 1 wt % dry mix with an alkali metal salt, preferably Na₂SO₄ or NaCl.

### Shading Dye

Shading dyes deposit to fabric during the wash or rinse step of the washing process providing a visible hue to the fabric.

The shading dyes used in the present invention are blue or violet. In this regard the dye gives a blue or violet colour to a white cloth with a hue angle of 240 to 345, more preferably 260 to 320, most preferably 270 to 300. The white cloth used is bleached non-mercerised woven cotton sheeting.

The shading dye preferably has a calculated log P (octanol-water partition coefficient) of between 0.5 and 3 more preferably between 1.0 and 2.5. Log P values are atom based and calculated using Molecular Modeling Pro (Chem SW®, version 5.2.2, © Norgwyn Montgomery Softwear limited).

The dye chromophore is preferably selected from the group comprising: mono-azo, triphenylmethane, naptholactam, azine and anthraquinone. Most preferably azine and anthraquinone.

Many examples of shading dyes are found in the classes of basic, solvent, acid, direct and disperse dyes.

Preferred shading dyes are:
(1) acid azine dyes as described in WO 2008/017570, preferably acid blue 59, acid blue 98 and acid violet 50.
(2) a cationic azine dye of the following form:

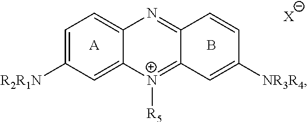

wherein X— is a negative anion;
no more than three of the groups R1, R₂, R₃ and R₄ are H and are independently selected from: a polyether chain, benzyl, phenyl, amine substituted benzyl, amine substituted phenyl, COCH₃, H, a linear or branched alkyl chains; a linear or branched alkyl chains which is substituted by one or more groups selected from: ester groups; Cl; F; CN; OH; CH₃O—; C₂H₅O—; and, phenyl;
R5 is selected from the group consisting of: a branched or linear C1 to C10 alkyl; a branched or linear C1 to C10 alkyl group substituted by a phenyl group; and, an aromatic group;
one or more of rings A or B may be further substituted to form a naphthyl ring; and,
the dye is not covalently bound to a negatively charged substituent.
(3) a cationic thiazolium dye, preferably of the form:

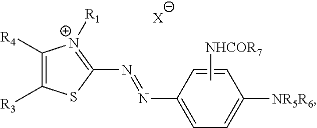

wherein R₁ is a branched or linear C1-C4 alkyl group;
R₃ and R₄ are independently selected from H, CH₃, and C₂H₅ or R₃ and R₄ are joined to form a benzene ring;
R₅ and R₆ are independently selected from: H, a branched or linear C1-C4 alkyl group, wherein the alkyl group chain may be substituted by OH groups, phenyl, COR₇, CH₂Ph, (C₂H₄O)ₙH wherein n is 2 to 5;
R7 is a branched or linear C1-C4 alkyl group; and,
X is a negative anion.
(4) a cationic isothiazolium dye of the following structure:

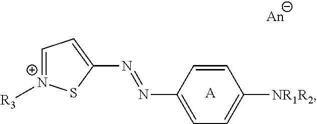

wherein
R₁ and R₂ are independently selected from H, alkyl, aryl; alkylaryl; alkylesters; polyethers; and R₁ and R₂ may be joined to form a five or six member aliphatic ring which may comprise a further hetroatom selected from oxygen and nitrogen;
R₃ is selected from: H; alkyl; alkylaryl; and, aryl; and,
the isothiazolium ring may be further condensed to a benzene ring.
(5) a cationic naptholactams dye of the following structure:

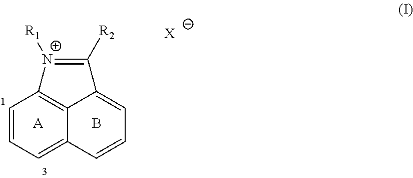

wherein:
X⁻ is a counter ion;
R1 is an optionally substituted alkyl which may form an alkylene bridge at the 1 position;
R2 is a group having at least one benzene moiety directly bound to a nitrogen atom, wherein the benzene moiety is between 1 and 4 bonds removed from the naptholactam and in conjugation with the naptholactam and rings A and B are optionally substituted.
(6) a cationic pyridine/pyridazine dye of the following structure:

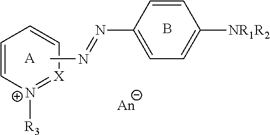

wherein
X is selected from: N; CH; and, C—N═N-phenyl(B)-para-NR1R2;
R₁ and R₂ are independently selected from H, alkyl, aryl; alkylaryl; alkylesters; polyethers; and R₁ and R₂ may be joined to form a five or six member aliphatic ring which may comprise a further hetroatom selected from oxygen and nitrogen;
R₃ is selected from: H; alkyl; alkylaryl; and, aryl; and,
Ring A may be further condensed to a benzene ring.
(7) hydrophobic dyes as follows:
(7a) solvent violet 13 and disperse violet 27 and an anthraquinone structure of the following anthraquinone structure (I):

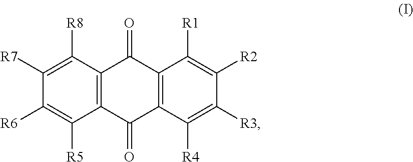

wherein R1, R4, R5, and R8 are independently selected from the groups consisting of —H, —OH, —NH₂, NHCOCH₃ and —NO₂, such that a maximum of only one —NO2 group and a maximum of two —H are present as R1, R4, R5, and R8 substituents; and R2, R3, R6, and R7 is selected from —H, F, Br, Cl or —NO₂, and —Oaryl.
(7b) mono-azo dye selected from a compound of the following formula:

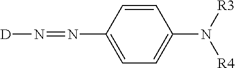

wherein R3 and R4 are optionally substituted C2 to C12 alkyl chains having optionally therein ether (—O—) or ester links, the chain being optionally substituted with —Cl, —Br, —CN, —NO₂, and —SO₂CH₃; and, D denotes an aromatic or hetroaromatic group. The aromatic rings may be further substituted by preferably —Cl, —Br, —CN, —NO₂, —SO₂CH₃ and —NHCOR and R is selected form CH₃, C₂H₅, and CH₂Cl.

Most preferred azo dyes are of the form

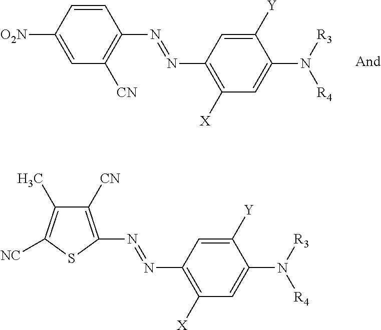

Where X and Y are selected from —Cl, —Br, —CN, —NO₂, —SO₂CH₃ and —NHCOR and R is selected form CH₃, C₂H₅, and CH₂Cl. Preferably X is NHCOCH₃ or NHCOCH₂Cl.

Shading of white garments may be done with any colour depending on consumer preference. Blue and Violet are particularly preferred shades and consequently preferred dyes or mixtures of dyes are ones that give a blue or violet shade on white fabrics.

A wide range of suitable solvent and disperse dyes are available. However detailed toxicological studies have shown that a number of such dyes are possible carcinogens, for example disperse blue 1. Such dyes are not preferred.

The following table illustrates calculated log P values for various dyes.

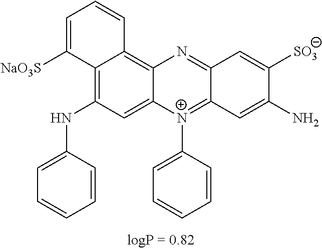

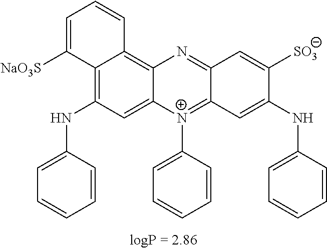

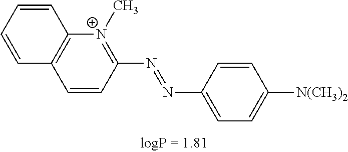

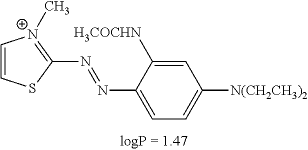

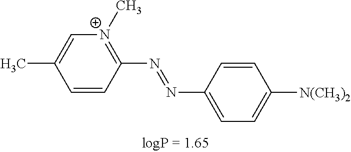

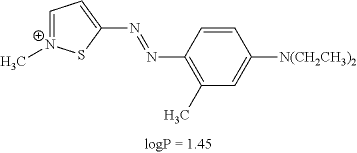

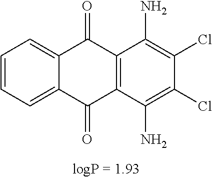

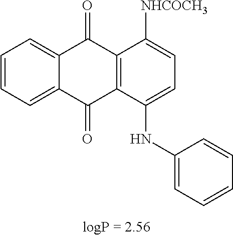

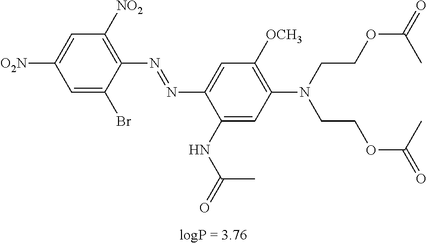

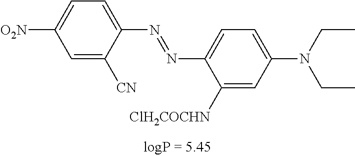

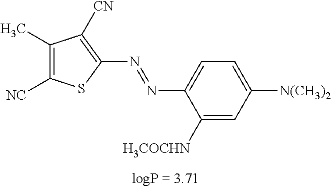

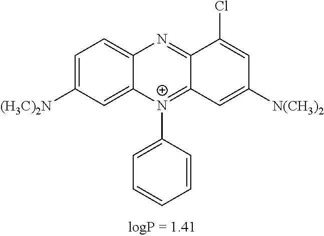

Most preferably the dye used in the invention is disperse violet 28.

### Builder

Builder materials may be selected from 1) calcium sequestrant materials, 2) precipitating materials,

3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate. Preferably, the laundry treatment composition comprises sodium carbonate in the range from 5 to 50 wt %, most preferably 10 to 35 wt %. In the method, when used with granular laundry treatment composition, the aqueous wash solution preferably comprises 0.1 to 4 g/L of sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders.

The composition may contain as builder a crystalline aluminosilicate, preferably an alkali metal aluminosilicate, more preferably a sodium aluminosilicate. This is typically present at a level of less than 15% w. Aluminosilicates are materials having the general formula:

0.8-1.5M₂O.Al₂O₃.0.8-6SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

Preferably the laundry detergent formulation is a non-phosphate built laundry detergent formulation, i.e., contains less than 1 wt % of phosphate.

### Enzymes

The composition may comprise one or more enzymes, which provide cleaning performance, fabric care and/or sanitation benefits.

Especially contemplated enzymes include proteases, alpha-amylases, cellulases, lipases, peroxidases/oxidases, pectases, lyases, and mannanases, or mixtures thereof.

Most suitable lipases are disclosed in WO 2007/087257.

### Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl.

### Perfume

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

Perfume and top note may be used to cue the whiteness benefit of the invention.

It is preferred that the laundry treatment composition does not contain a peroxygen bleach, e.g., sodium percarbonate, sodium perborate, and peracid.

### EXPERIMENTAL

### Example 1

Granules containing disperse blue 79:1 were mixed with Na₂SO₄ in the ratio 1:99. The disperse blue 79:1 did not contain any dispersant. The mix was dry mixed with a granular detergent powder (containing 20 wt % LAS, 30% carbonate 40% NaCl with the remainder minors including calcite), to give 0.005 wt % of the disperse blue 79:1 in the formulation.

A separate formulation was created containing 0.005 wt % of disperse blue 79:1 granules, which contained ˜50 wt % of dispersant (lignin sulphonate) and ˜50 wt % dye. The level of disperse blue 79:1 was therefore approximately half of the first formulation.

The formulations and a control without dye were used to wash a mixture of cottons, polyester-cottons, polyester, nylon-elastane and cotton-elastane fabrics at 20° C. with a liquor to cloth of 10:1, 26° FH water, 30 minute wash followed by 2, 1 minute rinses.

Following 10 washes the CIE L*a*b* values were measured using a reflectometer, and the values for the 2 dye containing formulation compared to the control, such that

Δb=b(control)−b(dye).

The results are given in the table below

Δb

| | Dye granule | Dye granule |
|---|---|---|
| Fabric | Without dispersant | with dispersant |
| Cotton | 0.35 | 1.12 |
| Polyester | 0.29 | 1.11 |
| containing | | |
| Elastane containing | 0.63 | 1.96 |

The formulation containing the dye granule with dispersant gives much better performance, despite having approximately half the level of dye.

### Example 2

The experiment of Example 1 was repeated for dye granules containing disperse violet 28 and disperse violet 63 in which both examples contained a dispersant. After 5 washes the following results were obtained.

Δb

| fabric | Disperse violet 28 | Disperse violet 63 |
|---|---|---|
| Cotton | 1.03 | 0.34 |
| Polyester containing | 0.74 | 0.28 |
| Elastane containing | 1.13 | 1.08 |

Good performance was obtained with the dye granules.

1. A granular laundry detergent composition comprising:
(a) from 0.00005 to 0.2 wt % of a dye granule, wherein the dye granule comprises:
(i) 20 to 60 wt % of a shading dye;
(ii) 40 to 80 wt % of a dispersant selected from: ligninsulphonates; alkali metal salts of the condensation products of naphthalenesulphonic acids and formaldehyde; polyvinylsulphonates;
and, ethoxylated novolacs;
(iii) 0 to 10 of wt % auxiliary agents selected from: anionic surfactants; non-ionic surfactants;
acidic polymers; and dust proofing oil;
(b) from 5 to 50 wt % of a surfactant;
(c) from 5 to 50 wt % builder selected from: calcium sequestrant materials; precipitating materials; and,
calcium ion-exchange materials; and,
(d) 0.05 to 50 wt % a water soluble carrier salt; and,
(e) 0 to 20 wt % other ingredients.

2. A granular laundry detergent composition according to claim 1, wherein the shading dye has a calculated log P (octanol-water partition coefficient) of between 0.5 and 3.

3. A granular laundry detergent composition according to claim 1, wherein the dispersant is a ligninsulphonate or the condensation products of naphthalenesulphonic acids and formaldehyde.

4. A granular laundry detergent composition according to claim 1, wherein the builder is selected from: carbonates; zeolites; silicates and sodium tripolyphosphate.

5. A granular laundry detergent composition according to claim 1, wherein the shading dye is disperse violet 28.

6. A granular laundry detergent composition according to claim 1, wherein the composition comprises a fluorescer selected from the group consisting of: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl.

7. A granular laundry detergent composition according to claim 1, wherein the composition comprises a perfume.
